(19) United States
(12) Patent Application Publication
(10) Pub. No.: US 2010/0269758 A1
(43) Pub. Date: Oct. 28, 2010

(54) Method for Producing an Absorbent Material, Absorbent Material and Use Thereof

(75) Inventor: Klaus Fuchshuber, Hoersching (AT)

Correspondence Address: JOYCE VON NATZMER;PEQUIGNOT + MYERS LLC, 200 Madison Avenue, Suite 1901, New York, NY, 10016, US

(73) Assignee: AGROS TRADING GMBH, Hoersching (AT)

(21) Appl. No.: 12/665,084

(22) PCT Filed: Jun. 27, 2008
(86) PCT No.: PCT/EP08/05289

§ 371 Date: Jul. 7, 2010

(30) Foreign Application Priority Data
Jun. 29, 2007 (EP) 07012790.7

(51) Int. Cl. A01K 29/00; B29C 47/62; B01J 20/22

(52) U.S. Cl. 119/171; 425/112; 502/403

(57) ABSTRACT

The invention relates to a method for manufacturing an absorbent material from at least one plant raw material and an absorbent material manufactured by this method. The invention further relates to uses of the absorbent material and an apparatus having at least one device for grinding grains.

The method according to the invention comprises the following steps:
grinding whole cereal grains;
extruding the ground cereal grains into spheres; and
grinding the spheres to form absorbent material.

Overall, an independently clumping absorbent material is produced via the method according to the invention from purely plant raw materials, by which liquids to be disposed of, such as, for example, oils, solvents, animal excrement or similar can be bound very rapidly and with high capacity.

### FIELD OF THE INVENTION

The invention relates to a method for manufacturing an absorbent material from at least one plant raw material, and an absorbent material manufactured by this method. The invention further relates to uses of the absorbent material and an apparatus having at least one device for grinding grains.

### BACKGROUND OF THE INVENTION

Absorbent materials are used in particular in decontamination, for example, the binding and removal of contamination by oil or solvents and as litter for animals. The absorbent materials are usually used in the form of granules or pellets having a large external and internal surface so that fairly large amounts of liquid such as, for example, oil, solvents or liquid excrements can be absorbed or bound.

Known from DE 102 44 122 C1, for example, is granular material for removing oil-like liquids from water surfaces which is demobilised in a mat. Lignite fraction, tree bark, peat, plant fibres, wood and sawdust are proposed here as granular material.

Also known from DE 42 03 928 A1 is a binder for mineral oils, chemicals and liquids which comprises cereal grains puffed by the action of heat, in particular maize or rice grains which are comminuted after the heat treatment to form a fine powder having a bulk weight of 50 g/l.

DE 198 24 132 A1 discloses a bedding for animal husbandry, comprising fibrous biological material such as straw, hemp, wood shavings or elephant grass. The fibrous material is initially comminuted to produce pellets and then pressed into pellets having a diameter of at least 20 mm.

DE 100 64 347 A1 discloses a litter for cats and small animals, wherein sugar beet cossettes and/or citrus pellets are used as absorbent material. In order to allow agglomeration of the dried plant material whilst supplying moisture, a water-soluble polymer is added as adjuvant to the material.

Further known from DE 195 43 311 C1 is an animal litter consisting essentially of wood particles to which guar flour was added to allow clumping when supplying moisture.

The most sold cat litter worldwide primarily comprises bentonite, a clay like material which clumps naturally when moisture is supplied. An animal litter made of bentonite is known, for example, from US-A-5 000 115. In addition, bentonite is also used as binder and thickener, according to DE 41 01 243 A1, for example, as an additive to cellulose-containing animal litter material, wood, paper or card.

However, the known absorbent materials have the disadvantage that either they are not made of 100% renewable raw materials and thus are not completely biologically degradable or cannot manage without additives which, for example, only make clumping possible. In addition, the already-known independently clumping materials are relatively heavy and not very high-yield.

### SUMMARY OF THE INVENTION

It is the object of the invention to provide an absorbing material and a method for manufacturing this material which clumps independently when moisture is supplied and is very high-yielding and has a low intrinsic weight.

The object is achieved by a method of the type specified initially, which comprises the following steps:

grinding whole cereal grains;

extruding the ground cereal grains into spheres; and

grinding the spheres to form absorbing material.

The method of manufacture according to the invention produces an absorbent material which is very light and high-yield. The extrusion produces an extremely large surface i.e. the spheres produced by the method according to the invention have a sponge-like structure with a very large absorbing surface. The absorbent material produced therefore absorbs liquids extremely rapidly and with a very high absorption capacity. In addition, aromatic substances are bound in a long-lasting manner. As a result of the production by the method according to the invention, the absorbent material has a very low weight (up to two thirds less than conventional products such as, for example, bentonite) so that the costs for transport and disposal are significantly lower. In addition, transport and disposal can, as a result, be made significantly more environmentally friendly. The method according to the invention therefore produces low-dust, highly porous spheres having a high suction force and odour-binding effect.

It has furthermore surprisingly been found that the processing of whole cereal grains produces an absorbent material which independently forms clumps when moisture is supplied. The apparent intrinsic clumping property of the plant material is further enhanced by the method of manufacture according to the invention. The absorbent material according to the invention can therefore be used without further adjuvants. Since the absorbent material is made of 100% natural, renewable raw materials, it is furthermore biologically degradable and compostable. As a result and due to the low intrinsic weight, disposal of the material is environmentally friendly and associated with significantly lower costs. When used as animal litter, the clumped absorbent material, i.e. wetted with urine, can, for example, simply be disposed of via the toilet, if this is allowed locally, so that fees for domestic waste can be saved. Overall, therefore an independently clumping absorbent material is produced via the method according to the invention from purely plant raw materials (whole cereal grains), by which liquids to be disposed of such as, for example, oils, solvents, animal excrement or similar can be bound very rapidly and with high capacity.

In a particularly advantageous embodiment of the method according to the invention, it is provided that the cereal grains are ground to a grain size of less than 3 mm, preferably less than 2 mm, particularly preferably less than 1 mm. Preferably a fraction of at most 20% of the ground cereal grains, particularly preferably at most 15%, has a grain size of less than 250 μm. A raw material prepared this way can be optimally further processed in the following extrusion step. If necessary, the ground cereal grains can be mixed once again before extrusion.

In order to achieve an optimal result in the extrusion step, the ground cereal grains should have a moisture content of 10 to 20%, preferably 12 to 15%, more preferably 13 to 14%, in particular 13.5%. If the actual moisture content should deviate from these values as a result of the nature of the cereal grains, it is, according to the invention, preferred that the moisture content can be specifically adjusted to the optimal value by moistening or drying.

Preferably, whole grain maize (Zea Mays) is processed as plant raw material in the method according to the invention. However, other cereal grains can also be used. In certain applications, for example, when used as animal litter, however, the absorbent material can be produced from a mixture of different types of cereal. In this case, it is provided that whole grains of different types of cereals are mixed before grinding. It has been found to be particularly advantageous, for example, if approximately 80 to 99% of whole grain maize is mixed with 1 to 20% of whole grain wheat, preferably 85 to 95% of whole grain maize is mixed with 5 to 15% of whole grain wheat, more preferably about 90% of whole grain maize is mixed with approximately 10% of whole grain wheat. Such a mixture leads to an absorbent material having exceptional clumping, low weight, best suction force and high absorption capacity as well as very good odour binding.

In a particular embodiment of the method according to the invention, it is further provided that the extruded cereal grains are additionally granulated so that the spheres can be adjusted to a defined size and a homogeneous final product or material can be obtained.

In particular, it is provided that the ground cereal grains are extruded or granulated to form spheres having a diameter of about 1 to 3 cm, preferably about 1.5 to 2.5 cm, particularly preferably about 2 cm.

In order that the advantageous structure of the material is preserved in the following process steps, it is provided that the spheres are cooled before grinding.

The grinding of the spheres after extrusion or granulation should preferably be carried out in such a manner that at least 80%, preferably at least 85%, particularly preferably at least 90%, in particular at least 95% of the particles of the absorbent material have a diameter of 0.2 to 10 mm, preferably 0.3 to 8 mm.

In order to obtain an as far as possible dust-free absorbent material, after grinding, the absorbent material can be sieved, wherein the sieving separates dust-like material, preferably material having a particle diameter of less than 0.4 mm, in particular less than 0.3 mm.

A particularly advantageous absorbing material is obtained if the material has a bulk weight between 300 and 500 g/l, preferably between 350 and 450 g/l.

The object is also achieved by an absorbent material which has been produced by means of the method according to the invention.

The object is further achieved by an absorbent material made of at least one plant raw material, in which the plant raw material is at least one cereal. The material made of cereal according to the invention independently forms clumps when moisture is supplied and can therefore be used without further adjuvants. It is not necessary to add clump-forming or odour-binding substances. Since the absorbent material is made of 100% natural, renewable raw materials, it is furthermore biologically degradable and compostable. As a result and due to the low intrinsic weight, disposal of the material is environmentally friendly and associated with significantly lower costs. The material according to the invention is therefore an independently clumping absorbent material via which liquids to be disposed of such as, for example, oils, solvents, animal excrement or similar can be bound very rapidly and with high capacity.

The material according to the invention preferably comprises cereal from the sweet grass (Poaceae) family. Particularly preferred are whole grain maize (Zea mays) and/or whole grain wheat (Triticum spec.).

Particularly preferred according to the invention is a material in which the plant raw material comprises a mixture of 80 to 99% whole grain maize and 1 to 20% whole grain wheat, preferably 85 to 95% whole grain maize and 5 to 15% whole grain wheat, particularly preferred are approximately 90% whole grain maize and 10% whole grain wheat. Such a mixture results in an absorbing material having excellent clump formation, low weight, best suction forces and high absorption capacity as well as good odour binding.

In a particular embodiment of the invention, the absorbent material according to the invention advantageously comprises particles of which at least 80%, preferably at least 85%, particularly preferably at least 90%, in particular at least 95% have a diameter of 0.2 to 10 mm, preferably 0.3 to 8 mm. Ideally the absorbent material should have a bulk weight between 300 and 500 g/l, preferably between 350 and 450 g/l. Such a material is very effective and easy to handle. In addition, it is very pleasant on contact so that, for example, when used as litter for pets, it is very soft to the paws of the animal and therefore very well accepted.

As a result of the said positive properties, the absorbent material according to the invention is optimally suitable for use as litter for animals. Depending on the size of the spheres, it can be used both for pets such as, for example, cats and also for larger animals such as, for example, horses.

As a result of the exceptional absorbency, however, the absorbent material according to the invention can also be used as decontamination means. In this case, it is particularly suitable for oil-like liquids, petrol or solvents since these can be absorbed very rapidly and can therefore be neutralised.

However, the absorbent material according to the invention can, for example, also be used as cleaning agent since it absorbs liquids very rapidly and is pleasant to handle for the user.

The invention also relates to an apparatus, in particular for carrying out the method according to the invention and/or for producing the absorbent material according to the invention, comprising at least one device for grinding grains, which is advantageously characterised in that an extruder is provided for producing spheres from the ground material. According to the invention, the extruder has at least two worm shafts which preferably each have a screw diameter of 60 to 70 mm, in particular 65 to 67 mm. The screw length is advantageously about 25 times the diameter (25×D). The extruder preferably has a drive power of 180 kW and reaches a maximum screw rotational speed of 800 rpm.

The extruder can additionally be provided with a granulator which preferably has 6 to 10 blades, in particular 8 blades. The granulator preferably has a drive power of 3 kW and reaches a maximum blade speed of 3000 rpm.

The apparatus according to the invention can further comprise, for example, a roll mill for grinding the extruded or granulated spheres, a cooling device for cooling the spheres and a sieve for separating dust particles.

### DESCRIPTION OF ADVANTAGEOUS AND PREFERRED EMBODIMENTS OF THE INVENTION

The invention is explained in detail hereinafter with reference to the following embodiment as an example.

Production of a litter made of maize and wheat for pets

Whole grain maize and whole grain soft wheat are mixed in a ratio of about 90% maize to about 10% wheat and then ground. The ground raw material should have a bulk density of more than 600 g/l and a moisture content of approximately 13.5%. The grain size should be less than 2 mm in diameter with a grain size distribution of at most 15% of particles having a diameter of less than 250 μm.

The ground cereal grains are mixed again and then extruded using a double-screw extruder to extrude spheres having a diameter of about 2 cm. The screws of the extruder each have a diameter of 66.2 mm. The screw length is 25×D. The extruder has a drive power of 180 kW and reaches a maximum screw speed of 800 rpm. The spheres are produced by means of a granulator which has eight blades and has a drive power of 3 kW and reaches a blade speed of 3000 rpm.

The spheres are cooled in a cooler and after about 1 hour ground using a roll mill to give the end product, i.e. to give absorbent material. Before packaging, the dust fraction having a particle diameter of less than 0.33 mm is separated by a sieve. The absorbent material then has a bulk weight of 350 to 450 g/l, the grain distribution being 95% between 0.33 and 8 mm.

The absorbent material thus product can be used, for example, as cat litter, wherein the particles immediately suck up liquid and form solid clumps. Odours are thereby enclosed. The clumps can be disposed of daily via the domestic toilet (if allowed), the organic waste collection bin or the household waste.

The absorbent material produced by the method according to the invention has the following advantages:

it is highly absorbent,

forms solid clumps,

binds odour rapidly and lastingly,

requires no adjuvants and additives,

is extremely gentle for the animals as a result of the granulation,

environmentally friendly disposal is possible,

since it is a natural product comprising 100% renewable plant raw materials,

it is 100% biologically degradable,

it is up to two thirds lighter than conventional clumping litter products,

it has a very low waste weight,

is low-dust,

easy to handle,

non-perfumed and

safe for humans, animals and the environment.

1. A method for producing an absorbent material from at least one plant raw materials, which comprises the following steps:
grinding whole cereal grains;
extruding the ground cereal grains into spheres; and
grinding the spheres to form absorbent material.

2. The method according to claim 1, characterised in that the cereal grains are ground to a grain size of less than 3 mm, preferably less than 2 mm, more preferably less than 1 mm.

3. The method according to claim 1 or 2, characterised in that a fraction of at most 20% of the ground cereal grains, preferably at most 15%, has a grain size of less than 250 μm.

4. The method according to any one of claims 1 to 3, characterised in that the ground cereal grains are adjusted to a moisture content of 10 to 20%, preferably 12 to 15%, particularly preferably 13 to 14%, in particular 13.5%.

5. The method according to any one of claims 1 to 4, characterised in that whole grains of different types of cereals are mixed before grinding.

6. The method according to claim 5, characterised in that 80 to 99% of whole grain maize is mixed with 1 to 20% of whole grain wheat, preferably 85 to 95% of whole grain maize is mixed with 5 to 15% of whole grain wheat, particularly preferably about 90% of whole grain maize is mixed with approximately 10% of whole grain wheat.

7. The method according to any one of claims 1 to 6, characterised in that the extruded cereal grains are additionally granulated.

8. The method according to any one of claims 1 to 7, characterised in that the ground cereal grains are extruded or granulated to form spheres having a diameter of about 1 to 3 cm, preferably about 1.5 to 2.5 cm, more preferably about 2 cm.

9. The method according to any one of claims 1 to 8, characterised in that the spheres are cooled before grinding.

10. The method according to any one of claims 1 to 9, characterised in that the grinding of the particles is carried out in such a manner that at least 80%, preferably at least 85%, more preferably at least 90%, in particular at least 95% of the particles of the absorbent material have a diameter of 0.2 to 10 mm, preferably 0.3 to 8 mm.

11. The method according to any one of claims 1 to 10, characterised in that after grinding, the absorbent material is sieved, wherein the sieving separates dust-like material, preferably material having a particle diameter of less than 0.4 mm, in particular less than 0.3 mm.

12. Absorbent material manufactured by the method according to any one of claims 1 to 11.

13. An absorbent material made of at least one plant raw material, characterised in that the plant raw material is at least one cereal.

14. The absorbent material according to claim 13, characterised in that the cereal can belong to the sweet grass (Poaceae) family, preferably whole grain maize (Zea mays) and/or whole grain wheat (Triticum spec.).

15. The absorbent material according to claim 13 or 14, characterised in that the plant raw material comprises a mixture of 80 to 99% whole grain maize and 1 to 20% whole grain wheat, preferably 85 to 95% whole grain maize and 5 to 15% whole grain wheat, more preferably approximately 90% whole grain maize and 10% whole grain wheat.

16. The absorbent material according to any one of claims 13 to 15, characterised in that the material comprises particles of which at least 80%, preferably at least 85%, more preferably at least 90%, in particular at least 95% have a diameter of 0.2 to 10 mm, preferably 0.3 to 8 mm, and/or that the material has a bulk weight between 300 and 500 g/l, preferably between 350 and 450 g/l.

17. Use of the absorbent material according to any one of claims 12 to 16 as litter for animals.

18. Use of the absorbent material according to any one of claims 12 to 16 as decontamination agent.

19. Apparatus, in particular for carrying out the method according to any one of claims 1 to 11 and/or for producing the absorbent material according to any one of claims 12 to 16, comprising at least one device for grinding grains, characterised in that an extruder is provided for producing spheres from the ground grains.

20. The apparatus according to claim 19, characterised in that the extruder has at least two worm shafts which preferably each have a screw diameter of 60 to 70 mm, in particular 65 to 67 mm.

21. The apparatus according to claim 19 or 20, characterised in that the extruder is additionally provided with a granulator which preferably has 6 to 10 blades, in particular 8 blades.
